(19) United States
(12) Patent Application Publication
(10) Pub. No.: US 2007/0206174 A1
(43) Pub. Date: Sep. 6, 2007

(54) Hand-Held Device For Measuring Distances

(75) Inventors: Gerhard Boegel, Balgach (CH); Hugh Baertlein, Lerici (IT)

Correspondence Address: ROTHWELL, FIGG, ERNST & MANBECK, P.C., 1425 K STREET, N.W., SUITE 800, WASHINGTON, DC, 20005, US

(73) Assignee: Leica Geosystems AG, Heerbrugg (CH)

(21) Appl. No.: 10/589,884

(22) PCT Filed: Feb. 18, 2005
(86) PCT No.: PCT/EP05/01703

§ 371 Date: May 25, 2007

(30) Foreign Application Priority Data
Feb. 19, 2004 (EP) 04003784.8

(51) Int. Cl. G01C 3/02

(52) U.S. Cl. 356/4.01

(57) ABSTRACT

A device for hand-held measurement of distances (d) to a surface region of an object (22), including a housing (2) and a lens system (3) for the optical measurement of distances (d). Transmission beams are transmitted via the lens system against the surface region and the beams (5) reflected there are recollected. The device additionally includes a first component (6, 7, 8, 8′, 8 9) connected to the housing (2) which may be extended beyond the housing for the measurement of short distances in the direction of emission of the transmitted beams and furthermore which acts as a spacer (9) for the optical measurement. The extended state of the component (6, 7, 8, 8′, 9) is automatically determined be a feeler device.

### CROSS-REFERENCE TO RELATED APPLICATION

This application is a National Phase of International Application Serial No. PCT/EP2005/001703, filed 18 Feb. 2005.

### BACKGROUND OF THE INVENTION

1. Field of the Invention

The invention relates to a device for hand-held measurement of distances to a surface region of an object.

2. Description of the Background Art

Such hand-held devices for optical measurement of distances have been known for years and hundreds of thousands of them are used today for a very wide range of applications, in particular in the construction industry. They can be used for optically measuring distances between a measuring stop of the device and a surface region of an object within a distance measuring range from a few decimeters up to, for example, 30 meters with an accuracy of a few millimeters. For measuring distances, modulated optical beams are transmitted by the device via a lens system to the object to be measured. At least part of the transmitted beams is reflected back by the surface region of the object in the direction of the device. Beams reflected by the surface region are collected again via the lens system a distance away from the transmitted beams and are converted by the receiver of the device into an electrical signal. On the basis of the propagation velocity of optical beams, the distance between the measuring stop and the surface region of the object can be determined by evaluating the electrical signal.

On the basis of a parallax between the transmitted beams and the collected, reflected beams a distance away from them, the collected, reflected beams are an increasing distance away from the center of the receiver on measurement to a surface region in the vicinity of the lens system. The smaller the distance from the surface region to be measured to the lens system, the fewer reflected transmitted beams can as a rule be converted by the receiver. Below a critical distance of the surface region from the lens system the electrical signal falls below a critical value, so that measurement of distances below a critical distance is adversely affected or even made completely impossible. The prior art discloses various measures for keeping the critical distance—below which optical measurement of distances is no longer possible—as small as possible.

DE 43 16 348 A1 discloses, for example, a device of this type for optical distance measurement, comprising a biaxial lens system and an optical fiber movable in the focal plane thereof. Collected beams reflected by an object and belonging to a laser bundle emitted by the device are transmitted to a receiver via the optical fiber. The optical fiber performs mechanical tracking depending on the distance of migrating, reflected beams. This tracking firstly adversely affects the speed of measurement and secondly requires a complicated construction. Nevertheless, distance measurements to objects within a critical distance of twenty centimeters in front of the lens system cannot be carried out.

WO 03/002 939 A1 discloses a hand-held device comprising a biaxial lens system for optical distance measurement and comprising an optical detector, which device has a photosensitive detection area formed so as to be extensive in the focal plane. By means of this detection area extensive in the focal plane a larger proportion of the collected, reflected beams migrating away with decreasing distances can be detected. In spite of the extensive detection area, however, this device, too, has a critical distance range up to about ten centimeters in front of the lens system, in which optical measurement of distances is not possible. In practice, short distances are therefore still measured by long-proven, physical measuring means—such as, for example, ruler or measuring tape.

### SUMMARY OF THE INVENTION

It is an object of the invention to eliminate deficiencies of the prior art and to provide a hand-held device for measuring distances to a surface region of an object, comprising a housing and a lens system for modulated transmitted beams and for beams reflected by the surface region, which device has a smaller critical distance below which measurement of distances is no longer possible.

A further object of the invention is to provide a device for measuring distances down to 0 cm.

A further object is the provision of a device by means of which at least two distance measurements can be carried out in parallel and can optionally be combined with one another—for example by addition, calculation of difference, area determination, etc.

These objects are achieved by a device having the features disclosed herein.

A device according to the invention for hand-held measurement of distances to a surface region of an object has a housing and a lens system let into the housing. For optical measurement of the distance to the surface region, modulated optical transmitted beams in the form of a bundle of beams are emitted by the device via the lens system toward the surface region. A part of those beams of the transmitted beams which are reflected by the surface region is collected again and electronically evaluated for determination of distances in the form of digital measured values by an evaluation unit. This method of distance measurement via the lens system is referred to below as electro-optical or as optical measurement. In addition, the device has a first component which is connected to the housing and is extendable beyond the housing for determining short distances in the propagation direction of the transmitted beams. According to the invention, the first component is formed in such a way that it can be used firstly for measuring short distances and secondly as a spacer for the optical measurement. The invention furthermore provides an apparatus for automatic determination of a distance dependent on the extension of this component.

The first component of the device according to the invention is designed in such a way that it can be extended to different differences beyond the housing, and that, in combination with the housing the distance to an object can be physically measured. For this purpose, the first component is designed in such a way that one end of the first component is led to the object, substantially parallel to the transmitted beam bundle, in the physical measurement. By determining the relative position between the component and the housing and taking into account the extension of the housing between the side thereof facing the object and the measuring stop in the direction of the transmitted beam bundle, the physically measured distance between the measuring stop and the object can be determined. Furthermore, the first component is also referred to simply as component, and a further component described below in an embodiment of the invention is referred to as further or second component. Physical distance measurement or measurement by means of the component is understood below as meaning a distance measurement with the component. Whether the distance measurement is effected with the first or second component is evident from the context.

The determination of the distance value can be effected in various ways.

The invention envisages measurement of the distance to be determined by the device by means of an electronic apparatus. The distance measured with the component is determined relatively or absolutely in a manner known per se on the basis of, in particular, an electromagnetic or optical principle of action. Advantageously the distance measured with the component is registered by means of contactless sensors. A measuring stop as zero point of the distance measurement is automatically also taken into account in the evaluation unit. The measuring stop is generally defined as the back of the housing, and under certain circumstances also as the front of the housing.

In the case of a component integrated in the housing, a scale or a code can be applied to the component and can be scanned by means of a scanning apparatus—for example with an optical sensor—in the housing. The measurement to the component or to scale or code on the component by means of a scanning apparatus is referred to below as—e.g. electro-optical, optical or magnetic-scanning, reading or tapping.

Depending on the arrangement of a sensor of the scanning apparatus, the evaluation unit takes into account a correction factor dependent on the distance from the sensor to the defined measuring stop for distance measurement by means of the component. The correction factor is then automatically added to or subtracted from the measured value by the evaluation unit. The procedure may be such that various alternatives of measuring stops, such as back of housing, front of the housing or an extended end of the completely or incompletely extended component, are stored in the evaluation unit and can be selected by a key of the corresponding measuring stop.

Another possibility is to coordinate a single defined measuring stop with the device and to provide correction factors for the individual measuring means of the device in the evaluation unit. Depending on the choice of the measuring means (optical measurement, measurement by means of component) the evaluation unit then automatically uses the respective correction factor and indicates the corrected value to the measuring stop as the distance value. Preferably, the evaluation unit registers the choice of the measuring means automatically, but of course input means for inputting the choice of the measuring means (e.g. key for electro-optical measurement) can equally well be provided.

The scanning of a scale or of a code on the component can be effected, for example, by means of a reflection scanner or a light barrier in a known manner. One possibility is to provide the component with transparent and opaque bars and to count the light-dark changes by means of a light barrier apparatus during extension of the component. The component is preferably automatically extended.

Another possibility is the magnetic scanning of a code, as known today in the prior art. If a magnetic flux is generated during extension of the component, it may also be possible to determine the magnitude of the magnetic flux (and of the extension) by means of a magnetic flux sensor. It could also be possible to use Hall sensors for position determination. The component may also be formed in such a way that it is pulled out or automatically extended for the measurement, snaps in, and triggers an electronic or acoustic pulse on snapping in.

The choice of the sensor can be based, for example, on a low-cost solution of a device or on a precision measuring device.

On the basis of the automatic determination of the distance measurement by means of the component and automatic taking into account of a defined measuring stop (e.g. taking into account the extension of the housing) it is also possible, in the case of physical measurement to determine a distance value present in digital form. The advantages of a measured value present in digital form—in particular for subsequent processing, storage or transmission of the measured value—are obvious. Transmission can also be effected for example, in a wireless manner by means of radio transmission or Bluetooth transmission to an external data processing apparatus.

According to the invention, the formation of the first component is such that the component can additionally be used for physical measurement of short distances, functioning as a spacer for the optical measurement. The formation of the component as a spacer permits measurement of short distances by an optical method. The component (also referred to below a spacer) extends, for example by a predetermined fixed length in the propagation direction of the transmitted beams beyond the housing. The predetermined fixed length is advantageously at least as great as the critical distance in front of the housing, in which optical measurements of surface regions are no longer possible, and is registered by means of an apparatus and transmitted to the evaluation unit. The automatically registered, predetermined fixed length of the spacer is taken into account by the evaluation unit with respect to the optical distance measurement in such a way that, in the extended state, the zero point for the optically measured, short distances is embodied by that end of the spacer which faces away from the housing. If the predetermined fixed length is chosen to be at least as great as the critical distance measured values for very short distances can also be obtained by means of optical measurement in digital form.

Other developments of the device according to the invention provide spacers which can be unfolded, in particular also automatically unfolded, or which can be automatically extended to a predetermined extended state. Both the spacer can be extended or folded and the choice of the measuring means can be communicated to the evaluation unit, for example by the press of a button. Automatic registration of the actuation of the spacer could also be effected acoustically, for example by detection of a click during unfolding.

If the spacer is not extended or pulled out to a predetermined extended state, the extended state can be determined by means of the abovementioned scanning apparatus and passed on to the evaluation unit. The evaluation unit then calculates the extended state of the spacer relative to a measuring stop as the zero point, i.e. as the measuring stop, for the optical measurement.

In one embodiment, a device according to the invention is formed in such a way that, in addition to the automatic scanning apparatus, a distance value measured by means of the component can additionally be determined simply by reading—for example via a first scale or a first read mark—by the user. The first scale and the first read mark may be arranged on the component or on the housing. Depending on the design of the component, on the other hand, the first scale may be arranged on the housing and the first read mark on the component. With a suitable design of the first scale, the physically measured distance value—from the measuring stop to the object—can be read via the first read mark by the user directly on the first scale. Reading by the user offers the possibility of reading distance values which are desired, for example, only for information or checking simply on a scale without digital measurement.

However, the invention can also be carried out in a manner such that a storage key is provided and the respective measured value is—if desired—stored by pressing the button after a measurement. Measured values which are not to be included or further processed are obtained in digital form and displayed but are automatically rejected again if the storage key is not pressed.

A further development of the invention envisages an additional second scale which is arranged on the housing and whose zero point is preferably embodied by the measuring stop and is advantageously arranged at a housing edge adjacent to the component. By means of the additional second scale, it is even possible physically to measure the distance of an object positioned in the immediate vicinity of the measuring stop using a device further developed in this manner. It is thus made possible in practice for many craftsmen to determine the sought distance value using a single device further developed in this manner.

A device according to the invention can also—as is usual in the case of measuring tapes—be further developed by a measuring hook arranged at one end of the component. It is also possible for a trailing stop to be coordinated with the measuring stop of the device. Further scales (e.g. in cm and inch) and a retraction apparatus, optionally with locking apparatus, for the component are also conceivable as further developments.

Advantageously, the component will be substantially completely retractable into the housing and will be held in the extended state by means of a force having a predetermined magnitude under frictional adhesion.

A guide of the component can additionally be formed in such a way that accumulated dirt is removable. Optionally, the device is formed in such a way that the guide is accessible for cleaning purposes, for example via a removable cover. Exchange of longitudinal measuring elements could also be provided.

In a further embodiment of the device according to the invention, a further component is provided. The device can then be equipped, for example, with two parallel components on or in two parallel lateral surfaces of the housing. Preferably, however, the further component is arranged orthogonally to the first component of the device according to the invention. This embodiment provides a device for hand-held measurement of distances having even more flexible properties. Orthogonal components are particularly suitable, for example, for surveys in corners as well as at windows and doors. In particular, two different distances can thus be measured in parallel. The component can be integrated in the housing, for example can be extendable as rollers or in a telescopic manner. Another possibility is integration of the components in the outer walls of the housing. The components can, however, also be formed so that they can be easily folded or pulled out, for example as folding rulers, and can be fastened to the outer walls of the housing. Thus, the components can, for example, be in the form of rulers having foldable or slidable sections with a magnetic rail on the innermost section and can be capable of being fastened on metal rails in or on the outer housing walls.

An advantageous embodiment of the invention provides one or more components on the apparatus, which components can be extended beyond the housing on both sides. Thus, the measuring stop of the device can be pushed backward, for example by means of a component extending beyond the back of the housing, and the device can be used, for example, for measurement from inaccessible points.

### BRIEF DESCRIPTION OF THE DRAWINGS

Below, the invention is explained in more detail with reference to nine measuring arrangements shown schematically in the figures, with eight working examples of devices according to the invention. The working examples each contain features in combination. Features from different working examples can be combined here to give further expedient combinations. Identical parts in different working examples which perform the same function are provided as identical designations and reference numerals. The figures show the following schematically:

FIG. 1 shows a first measuring arrangement for optical and physical measurement of a distance to a cuboid, with a first working example of a device according to the invention, in partial section in plan view,

FIG. 2 shows the first measuring arrangement from FIG. 1 in side view,

FIG. 3 shows a second measuring arrangement for physical measurement of a very short distance to the cuboid, with the first working example in side view,

FIG. 4 shows a third measuring arrangement for measuring a dimension of the cuboid, with the first working example in the turned state in side view,

FIG. 5 shows a fourth measuring arrangement for physical measurement of a short distance to the cuboid, with a second working example of a device according to the invention in partial section in plan view,

FIG. 6 shows the second measuring arrangement from FIG. 3, with the second working example in plan view,

FIG. 7 shows a fifth measuring arrangement with the cuboid and an angle-piece and the second working example in plan view.

FIG. 8a shows the fourth measuring arrangement from FIG. 5, with a third working example of a device according to the invention in plan view,

FIG. 8b schematically shows a cut-out of the measuring stick from FIG. 8a with a light barrier;

FIG. 9 shows a sixth measuring arrangement with a fourth working example with a further component of a device according to the invention, in partial section in plan view,

FIG. 10 shows a seventh measuring arrangement for measuring the depth of a bore of a cube shown cut away and a fifth working example of a device according to the invention in side view,

FIG. 11 shows an eighth measuring arrangement with the angle-piece and a sixth working example of a device according to the invention, in partial section in plan view,

FIG. 12 shows a ninth measuring arrangement with the cube and a seventh working example, in partial section in plan view,

FIG. 13 shows the ninth measuring arrangement from FIG. 12, with an eighth working example in partial section in plan view.

### DETAILED DESCRIPTION OF THE INVENTION

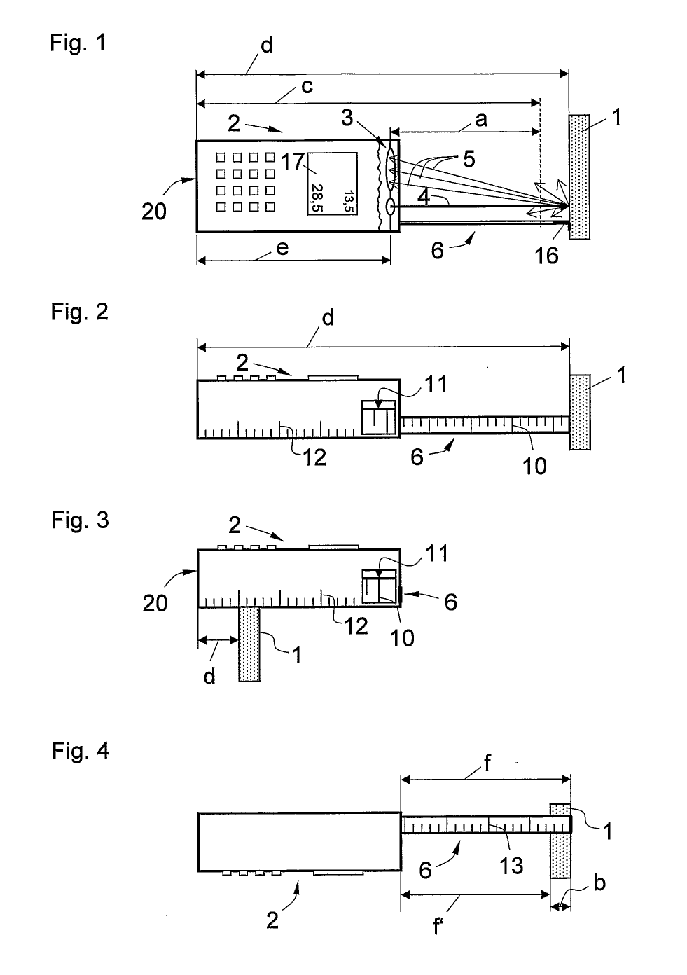

FIG. 1 shows a first measuring arrangement for optical and physical measurement of the distance d to a surface region of an object shown here as cuboid 1, with a first working example of a hand-held device according to the invention, shown partly cut away, in plan view.

The working examples of devices according to the invention which are shown in the figures have in each case a housing 2 having a length of, for example, 15 centimeters. A lens system 3 shown in section only in FIGS. 1, 11, 12 and 13 and intended for optical measurement of distances is let into one side of the housing 2. Here, the lens system 3 has a transmission segment and a receiving segment arranged adjacent thereto. The transmission segment and the receiving segment are in each case part of a transmission channel and receiving channel, respectively, of the device. The back 20 of the housing 2, which is opposite the side into which the lens system 3 is let, is formed here—as usual in the case of such measuring apparatuses—as a measuring stop. In the measurement of distances d, said measuring stop usually embodies the zero point thereof.

As is evident from FIG. 1, modulated optical transmitted beams 4 are emitted toward the cuboid 1 via the transmission channel for the optical measurement of distances d. The extension e of the housing 2 between the lens system 3 and the back 20 in the direction of propagation of the transmitted beams 4 does not quite correspond to the length of the housing 2 in the present working examples. Depending on the arrangement of the measuring stop on the housing 2, this dimension could, however, also assume another value.

The cuboid 1 has a naturally rough surface from which optical beams are reflected with scattering. A part of the beams 5 reflected with scattering is collected by the lens system 3, detected, and converted into an electrical signal. The signal is evaluated in a manner known per se by an electronic evaluation unit for determining the digital value of the distance d. The extension e between the lens system 3 and the back 20 which forms the measuring stop here is taken into account. The value of the electro-optical distance measurement determined digitally by the evaluation—of, for example, 28.5 centimeters here—is then made available on a display 17 to a user of the working examples.

Because of the optical geometrical circumstances of the transmission and receiving channel of the working examples, detection of emitted beams 5 reflected by the surface of the cuboid 1 with scattering is possible only if the surface is at least a critical distance a of, in this case, about 10 centimeters away from the lens system 3. The working examples thus have a critical distance c shown in FIG. 1—between the back 20 serving as the measuring stop and that region of the surface of the cuboid which is illuminated by the transmitted beam bundle 4—of about 25 centimeters in this case. Below the critical distance c, optical measurement is no longer possible. With measuring apparatuses which correspond to the working examples, optical measurement to surfaces reflecting with scattering is possible above the critical distance c to distances d of, typically, 30 meters.

According to the invention, the working examples shown in the figures have a first component which is connected to the housing 2 and is formed for measuring short distances and as a spacer for the electro-optical measurement. In FIGS. 1 to 10, the component is shown only in its function of physical measurement of a distance d but can of course just as well be used as a spacer for the electro-optical measurement.

In the first working example of FIGS. 1 to 4, the component is in the form of measuring tape 6. The measuring tape 6 can, for example, be produced from an arched, elastically flexible steel tape. The measuring tape 6 has, on the side facing away from the transmitted beams 4 in FIG. 1, a first scale 10 shown only in FIG. 2 and, on the side facing the transmitted beams 4, a third scale 13 shown only in FIG. 4.

Here, the measuring tape 6 has a somewhat shorter length than the housing 2. The measuring tape 6 can therefore be completely retracted into the housing 2 in a simple manner—also without a separate deflection or roll-up mechanism necessary for this purpose. This length of the measuring tape 6 therefore permits not only physical measurement of distances d within the critical distance a to the lens system 3 but also physical measurement in an overlap region which is adjacent to the critical distance and in which both physical and optical measurement of the distance d are possible. Consequently, the convenience of operation can be increased and additionally the reliability of measurement can be increased in a manner known per se.

In the first working example, the extendable end of the measuring tape 6 is in the form of measuring hook 16. However, the end could also be formed directly by the end face of the measuring tape 6. Here, the measuring hook 16 is connected—in a manner known per se—to the measuring tape 6 so as to be displaceable by the material thickness of said measuring hook. It is thus possible to carry out measurements conveniently according to the third measuring arrangement from FIG. 4.

In the first working example, the measuring tape 6 is guided by a guide not visible in FIGS. 1 to 3 and formed integrally with the housing 2. By means of, for example, a felt pressing on the component or a pretensioned spring element, a frictional force is thus exerted on the component in such a way that firstly adjustment is possible without application of considerable force and secondly the measuring tape 6 is held in the extended state by frictional adhesion.

As is evident from FIG. 1, the distance d to the surface of the cuboid 1 can also be measured physically by means of the component in the form of measuring tape 6 in combination with the housing 2—as an alternative to the optical measurement. For the physical measurement of distances d, in a first step the distance between that region of the surface of the cuboid 1 which is illuminated by the transmitted beam bundle 4 and the lens system 3 along the direction of propagation of the transmitted beams 4 is measured with the aid of the measuring tape 6. For this purpose, one end of the measuring tape 6 is led beyond the housing 2, substantially parallel to the transmitted beams 4, to the cuboid 1. For measuring distances d between the back 20 serving as measuring stop and the surface of the cuboid 1, in the first measuring arrangement the end of the measuring tape 6 is caused to abut the surface of the cuboid 1, and the relative position between the measuring tape 6 and the housing 2 is then automatically determined. The determination of the relative position is effected by means of a reflection scanner in the housing 2, which scans the first scale 10 shown in FIG. 2. The determination can also be effected by scanning the third scale 13 shown in FIG. 4. Taking into account the extension e of the housing 2 in the direction of the transmitted beams 4 from the lens system 3 to the back 20, the distance d between the measuring stop and the surface of the cuboid 1 is determined in a second step and output as a digital value.

With the aid of the component in the form of measuring tape 6, distances d, in particular in the region between the length of the housing 2 and the distance c critical for optical measurement, can be physically measured in a simple manner, automatically determined and output as digital values using a device according to the invention.

The first working example has a reflection scanner as an electronic apparatus for determining the relative position between the measuring tape 6 in this case and the housing 2. The electronic apparatus can be activated by means of a key on the housing. Thus, as also in the case of optical measurement—a digital value for the distance d can be determined and can be indicated on the display 17. The value present in digital form can also advantageously be stored by the apparatus—as is usual today in the case of optically measured distance—and can be further processed or transmitted.

The digital value can also be transformed without problems into another reference system—for example with the front of the housing 2 opposite the back 20 as zero point. The value shown as a somewhat smaller value on the display 17—for example 13.5 centimeters here—thus corresponds to the distance between the surface of the cuboid 1 and the front of the housing 2.

In addition—as is evident from FIG. 2—the physically measured distance d can be read directly by a user on a first scale 10 arranged on the measuring tape 6 via a first read mark 11 arranged, for example, on the housing 2.

FIG. 2 shows the measuring arrangement from FIG. 1 in side view. A magnifying read window having the first read mark 11 is let into a lateral surface of the housing 2, which lateral surface is parallel to the measuring tape 6. The first scale 10 is designed so that, in the case of the first read mark 11 the value for the physically measured distance d—28.5 centimeters here—can be read directly by the user.

An alternative working example without a read window would also be conceivable. The value of the measured distance d to the cuboid 1 could, for example, also be read directly via the front as an alternative first read mark on an alternative first scale. The alternative first scale would then be arranged somewhat shifted on the measuring tape 6 relative to the first scale 10.

By means of such a development of the device according to the invention, it is possible for the user to read physically measured distances on the measuring tape 6 or at the read mark 11 without automatically obtaining a digital distance value. It is left to the user to activate the electronic apparatus for automatic determination of the position of the measuring tape 6 or simply to read the value—for example for subsequent checking.

FIG. 3 shows a second measuring arrangement for physical measurement of a very short distance d to the cuboid 1 with the first working example in side view.

A second scale 12 is arranged on a lateral surface of the housing 2, which surface is aligned parallel to the measuring tape 6, for measuring very short distances d along an edge of the housing 2. With the aid of the second scale 12, it is even possible to measure distances d which are smaller than the length of the housing 2. The zero point of distances which can be read on the scale 12 is likewise embodied by the back 20. It is possible in principle to measure physically any distance d below the critical distance c from FIG. 1 with the first working example by means of the second scale 12, the first read mark 11 and the first scale 10, via the housing 2 of a measuring tape 6.

FIG. 4 shows a third measuring arrangement in side view, in which a dimension b of the cuboid 1 is measured with the first working embodiment in the turned state. The third scale 13 is arranged on that side of the measuring tape 6 which faces the transmitted beams 4 in FIG. 1. In contrast to the first scale 10 from FIG. 2 which is arranged on the opposite side, the zero point of the third scale 13 is embodied here by the extendable end of the measuring tape 6. By means of the third scale 13, it is possible to measure even small dimensions of an object or relatively small distances between objects in a simple and convenient manner with extended measuring tape 6.

By means of the front of the housing 2 as a read mark, it is also possible to read the distance f between the extended end of the measuring tape 6 and the housing 2 directly on the third scale 13. On activation of an automatic scanning apparatus for scanning the third scale 13, the value for the distance f is output digitally. In order to read both scales 10, 13 of the measuring tape 6 automatically, two scanning apparatuses should be provided in the housing. Another possibility is to form the scales 10, 13 identically and to provide a single scanning apparatus.

In addition to the determination of the dimension b of the cuboid 1 and distance f to the housing using the measuring tape 6, the distance f′ to the cuboid 1 can be measured electro-optically.

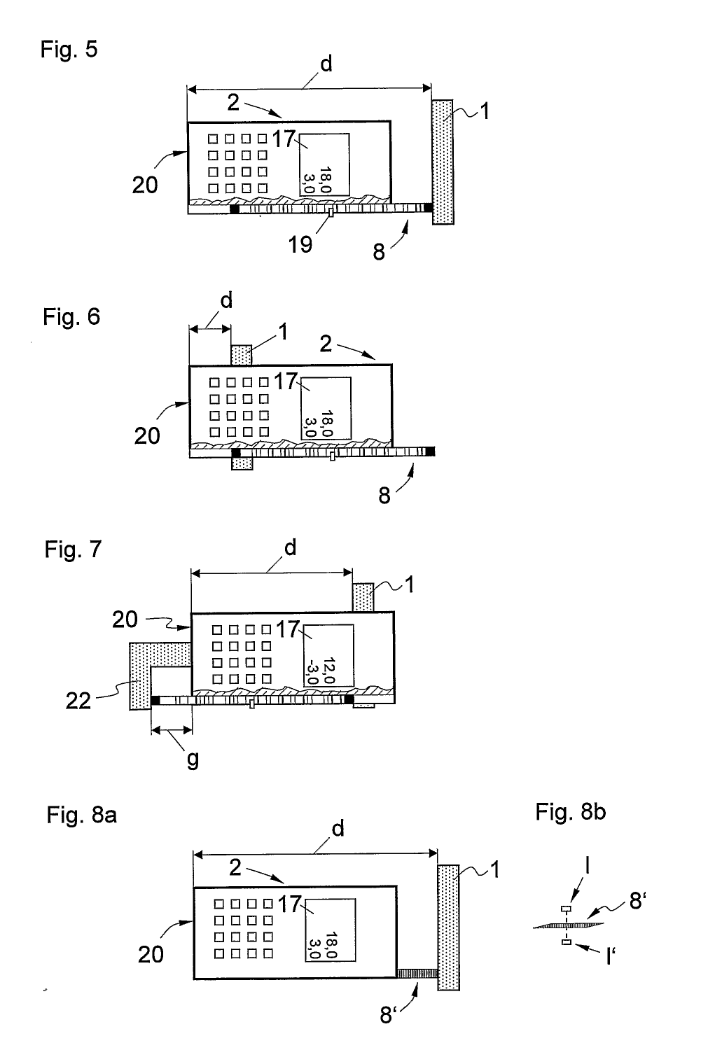

FIG. 5 shows a fourth measuring arrangement with the cuboid 1 and a second working example of a device according to the invention, shown partly cut away.

The second working example is shown in FIGS. 5, 6 and 7 in plan view and in partial section so that a component in the form of measuring stick 8 and its guide formed integrally with the housing 2 are visible.

Here, the measuring stick 8 is provided with an actuating lever 19. In contrast to the first working example, the second working example has no scales by means of which a user can read distances, spacings or dimensions of objects directly. Here, the position of the measuring stick 8 relative to the housing 2 is determined electro-optically by means of a barcode applied to the surface of the measuring stick 8, the distance d is determined by taking into account the length of the housing 2, and said distance is reproduced on the display 17. The measuring stick 8 advantageously has the same length as the housing 2.

The measuring stick 8 is best guided in the vicinity of a bottom edge of the housing 2, which edge—as shown in FIGS. 5, 6 and 7—is adjacent to the transmitted beam 4 in FIG. 1. In contrast to the first working example here the measuring stick 8 is extendable beyond the housing 2 on both sides. Advantageously, the housing 2 is transparent in the region of the guide so that both ends of the measuring stick 8 can be inspected for measuring purposes. Here, the guide also has a slot for the actuating lever 19, which slot is not shown.

In the fourth measuring arrangement of FIG. 5, the distance d between the back 20 of the housing 2 and the surface of the cuboid 1 is measured physically as in the case of the first measuring arrangement, using the second working example. For this purpose, the front end of the measuring stick 8 is led by a movement relative to the housing 2 to the surface of the cuboid 1, the relative position is automatically determined and the distance corresponding to the front end of the component—18 centimeters here—is reproduced on the display 17.

FIG. 6 shows the second measuring arrangement from FIG. 3 with the cuboid 1 and the second working example, shown partly cut away, in plan view, for determining the digital value of the very short distance d from the back 20 of the housing 2 to the surface of the cuboid 1.

For this purpose—as shown in FIG. 6—the back end of the measuring stick 8 is positioned over that surface of the cuboid 1 which is to be measured, the relative position is automatically determined and the distance d corresponding to the back end—3 centimeters here—is reproduced on the display 17.

FIG. 7 shows a fifth measuring arrangement with the cuboid 1 and an angle-piece 22 and a partly cut-away second working example in plan view.

With the second working example, the distance d from the back 20 of the housing 2 to the surface of the cuboid 1 can be determined by moving the measuring stick 8 beyond the back 20 until a front end of the measuring stick 8 comes to lie over the surface to be measured. The measurement can now be triggered and both the distance corresponding to the front end and the distance corresponding to the back end—for example 12 and −3 centimeters, respectively, here—can be reproduced on the display 17.

As likewise shown in FIG. 7, the dimensions g of the step of the angle-piece 22 can also be determined in a digital manner via the back end of the measuring stick 8, which extends here beyond the back 20.

FIG. 8a shows the fourth measuring arrangement of FIG. 5 with a third working example of a device according to the invention. Here, a measuring stick 8′ has neither a scale nor a code but a pattern of alternating opaque and transparent bars. FIG. 8b schematically shows a cut-out of the measuring stick 8′ with a light barrier with emitter 1 and detector 1′. A laser beam emitted by the emitter 1 and detected by the detector 1′ is shown by a dashed line. The measuring stick 8′ and the light barrier are arranged in the housing 2 in FIG. 8a. The measuring stick 8′ is automatically extended from the housing 2, and the light-dark changes or the bars are counted in a known manner by means of the light barrier. From the counted bars, the distance physically measured using the measuring stick 8′ is determined as a digital value. Distance d from the measuring stop of the device to the surface of the cuboid 1 is displayed digitally. For the output or display of the distance value it is possible to choose between the housing back 20 and the housing front as the measuring stop. Here, the value measured from the housing back 20 or housing front as a measuring stop corresponds to the displayed distance value of eighteen or three centimeters, respectively.

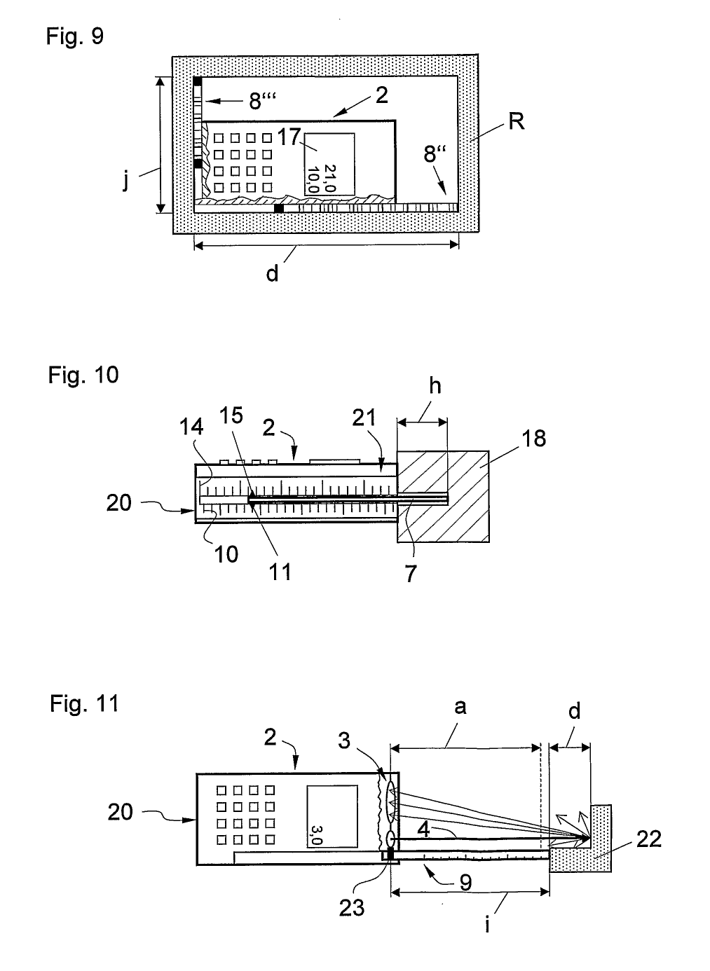

FIG. 9 shows a sixth measuring arrangement for surveying a frame R with a fourth working example of a device according to the invention in plan view in partial section so that two components in the form of measuring sticks 8″, 8′″ and their guides formed integrally with the housing 2 are visible. Here, a further or second component in the form of measuring stick 8′″ is coordinated with the hand-held distance-measuring apparatus in addition to a first component in the form of measuring stick 8″. The measuring sticks 8″ and 8′″ are guided in transparent guides formed integrally with the housing 2 and are automatically extendable. The guides or the measuring sticks 8′, 8′″ are arranged orthogonally and slightly offset from one another. In the case of components shorter than the length or width of the housing, the orthogonal arrangement could also be effected in a plane. Here, the measuring sticks 8″, 8′″ are provided with codes which are magnetically scanned. For this purpose, two scanning apparatuses are arranged in the housing 2. The digitally displayed measured values of twenty one and ten centimeters correspond to the distance values d, j from the housing back and lateral edge of the housing as a respective measuring stop. The arrangement of a further component in the form of measuring stick 8′″ orthogonally to the first component of a device according to the invention, in the form of measuring stick 8″, is suitable in particular for surveys of internal dimensions of frame parts, such as windows and doors. Preferably, both components can be extended from the housing on both sides.

FIG. 10 shows a seventh measuring arrangement, for example for measuring the depth h of a bore of a cube 18 shown in section, with a fifth working example of a device according to the invention in side view.

The fifth working example has a housing 2 having a receptacle not visible in FIG. 10 and a length measuring module 21 in which a component in the form of a measuring spindle 7 is guided. The length measuring module 21 is detachably connected to the housing 2 via the receptacle. Here, the measuring spindle 7 is in the form of a rod-shaped, substantially rigid body which can be produced, for example, from plastic.

In contrast to the first working example, here the first scale 10—for reading the physically measured distance d of FIG. 1—is not arranged on the measuring spindle 7 but in this case on the length measuring module 21. In addition, a fourth scale 14 whose zero point here is embodied by the front opposite the back 20 is also arranged on the length measuring module 21. The first and a fourth read mark 11 and 15 respectively, are arranged here at the back end of the measuring spindle 7.

For determining the depth g of the bore, the front of the housing 2 is placed against the cube 18, and the measuring spindle 7 is pushed to the bottom of the bore. The depth h of the bore can be read on the fourth scale 14 via the fourth read mark 15.

The detachable connection of the length measuring module 21 to the receptacle of the housing 2 is formed in such a way that, in the connected state, the first and the fourth scale 10 and 14, respectively, have a predetermined position relative to the front and back 20, respectively. This can be effected in a manner known per se, for example by means of positioning elements.

A modular design of the component and of its guide has the advantage that hand-held devices which can be retrofitted for measuring short distances are permitted.

In FIGS. 1 to 10, the device according to the invention is provided with a first component shown in various versions, which component is shown only in its function as a distance measuring means. In FIGS. 11 to 13, measuring arrangements are now discussed in which the first component is used as a spacer. However, the first component of the device according to the invention, which component is shown in FIGS. 1 to 10, can of course also be used in its different versions in each case as a spacer.

FIG. 11 shows an eighth measuring arrangement comprising the angle-piece 22 and a sixth working example of a device according to the invention in plan view, which working example is shown partly cut away.

The sixth working example has a component in the form of spacer 9. Here, the spacer 9 is pivotably connected to the housing 2 by means of a pin 23.

In the conventional optical measurement of distances between the back 20 of the housing 2, which forms the measuring stop, and objects a sufficient distance away, the spacer 9 is lowered in the housing 2 in the swiveled-in state. On the other hand, in the measurement of short and very short distances d, the spacer 9 is swiveled out and thus extends—in the direction of propagation of the transmitted beams 4—in a predetermined fixed length i starting from the lens system 3 beyond the housing 2.

In the case of the first five working examples, short and very short distances d are physically measured by leading one end of the component, by a movement relative to the housing 2, to the surface to be measured. Alternatively, in the sixth working example, the spacer 9 is on the other hand swiveled out. The measuring stop used is now no longer the back 20 of the housing 2 but the swiveled-out end of the spacer 9.

If—as shown in FIG. 11—the predetermined fixed length i is chosen to be at least as large as the critical distance a, maintenance of the critical distance a is ensured thereby, with the result that very short distances can also be measured optically. The measured values are thus present in digital form even without a separate apparatus for determining the relative position between the component and the housing 2.

The working example advantageously has an apparatus not shown in FIG. 11 for registering the predetermined extended state of the spacer 9—for example a simple mechanical switch. If the device according to the invention registers that the spacer 9 is present swiveled out in a predetermined extended state, the front end of the spacer 9 is automatically taken into account as the zero point of the displayed distance d—for example three centimeters here—in the determination of the distance d. In the case of conventional optical measurement with swiveled-in spacer 9, on the other hand the back 20 can automatically be taken into account as measuring stop and zero point of the measured distance with the aid of the apparatus for registration. In this way erroneous assignments of the two different measuring stops to the respective types of distance measurement can be prevented.

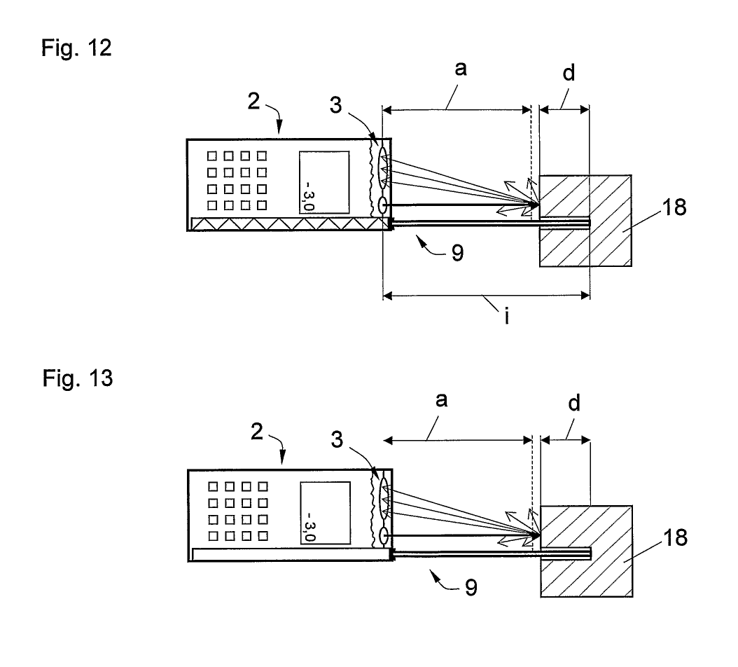

FIG. 12 shows a ninth measuring arrangement with the cube 18 from FIG. 10 and with a seventh working example shown partly cut away in plan view.

In contrast to the sixth working example, the spacer 9 cannot be swiveled out but is connected to the housing so as to be extendable. In the extended state, the spacer 9, which has a spindle-like form here, is pressed against a stop of the housing 2 by a spring, only indicated schematically, and thus extends a predetermined length i beyond the housing 2. The fifth working example is advantageously likewise provided with an apparatus for registering the spacer 9 extended up to the stop, which apparatus is not shown.

Here, the length i of the spacer is greater than in the sixth working example from FIG. 11, resulting in a larger measuring range in which comparable measurements can be carried out with this measuring arrangement.

FIG. 13 shows the ninth measuring arrangement from FIG. 12, with an eighth working example shown partly cut away in plan view. The spacer 9 is automatically extended up to a measuring point and held in this position. A sensor registers the extended position of the component by scanning a scale on the component, which scale is not shown in FIG. 13. The extended end of the component is then considered to be the measuring stop for the optical distance measurement.

1. A device for hand-held measurement of distances (d) to a surface region of an object (1, 18, 22), comprising
a housing (2),
a lens system (3) let into the housing (2) and intended for modulated transmitted beams (4) and for those beams (5) of the transmitted beams (4) which are reflected by the surface region, for electro-optical distance measurement and
a first component (6, 7, 8, 8′, 8″, 9) which is connected to the housing (2) and can be extended beyond the housing (2) in the direction of propagation of the transmitted beams (4) for determining short distances (d),
wherein
the first component (6, 7, 8, 8′, 8″, 9) is formed both for measuring short distances, in particular between a zero point given by a measuring stop (20) of the housing (2) and the surface region, and as a spacer for electro-optical distance measurement and
means for automatic determination of a distance dependent on the extension of the first component (6, 7, 8, 8′, 8″, 9), both for distance measurement and for fixing the zero point for electro-optical measurement, are provided.

2. The device as claimed in claim 1, wherein the means for automatic determination comprise
optical or
magnetic or
acoustic or
touch-sensitive or pressure-sensitive sensors.

3. The device as claimed in claim 1, wherein the device has at least one further component (8′″), optionally arranged orthogonally to the first component (8″) for measuring short distances.

4. The device as claimed in claim 3, wherein an apparatus, such as an optical, magnetic, acoustic or touch-sensitive or pressure-sensitive sensor, for automatic determination of the short distance is coordinated with the further component (8′″).

5. The device as claimed in claim 1, wherein
the first component (9) extends a predetermined fixed length (i) beyond the housing (2) for electro-optical measurement of short distances (d), and
in the predetermined extended state of the first component (9), the zero point of the measured, short distance (d) is embodied by that end of the first component (9) which faces away from the housing (2).

6. The device as claimed in claim 5, wherein an apparatus for registering the predetermined extended state of the first component (9) is provided.

7. The device as claimed in claim 5, wherein the first component (9) can be swiveled out or extended to the predetermined extended state, optionally with locking.

8. The device as claimed in claim 3, wherein
a scale or
a code
is coordinated with the first and/or further component (6, 7, 8, 8′, 8″, 8′″, 9).

9. The device as claimed in claim 3, wherein the first and/or further component is in the form of one of the following alternatives:
elastically deformable, in the form of a strip,
as an elongated, substantially rigid body,
arranged in a length measuring module detachably fastened to the housing (2), in particular via a receptacle.

10. The device as claimed in claim 3, wherein the guide of the first and/or further component (6, 7, 8, 8′, 8″, 8′″, 9) is formed in such a way that it is held in the extended position with frictional adhesion.

11. The device as claimed in claim 3, wherein the remote end of the first and/or further component (7, 8) is in the form of measuring hook (16), which is optionally displaceable by the material thickness of the measuring hook (16).

12. The device as claimed in claim 1, wherein a third scale (13) is arranged on the first component (6, 7, 9), the zero point of which third scale is embodied by that side of the component (6, 7, 9) which faces away from the housing.

13. The device as claimed in claim 1, wherein at least one second scale (12) for measuring distances is arranged on the housing (2), the zero point of which second scale is embodied by the measuring stop (20).
